(19) United States
(12) Patent Application Publication
(10) Pub. No.: US 2026/0285760 A1
(43) Pub. Date: Sep. 24, 2026

(54) COMPOSITIONS AND METHODS OF MAKING CEMENTITIOUS BINDERS WITH LOW CO2 FOOTPRINT

(71) Applicant: C-CRETE TECHNOLOGIES LLC, San Leandro, CA (US)

(72) Inventors: Rouzbeh SAVARY, San Leandro, CA (US); Sanan EMINOV, San Leandro, CA (US)

(21) Appl. No.: 19/478,962

(22) PCT Filed: Apr. 29, 2024
(86) PCT No.: PCT/US2024/026827

§ 371 Date: Oct. 27, 2025

Related U.S. Application Data
(60) Provisional application No. 63/498,688, filed on Apr. 27, 2023.

(51) Int. Cl. C04B 28/12; C04B 103/10

(52) U.S. Cl. CPC C04B 28/12; C04B 2103/10; C04B 2201/50

(57) ABSTRACT

A cementitious material with a reduced carbon dioxide (CO₂) footprint is disclosed, comprising lime containing CaO, Ca(OH)2, or their combinations, and a pozzolanic material such as metakaolin, calcined clay, volcanic tuffs, calcined shale, municipal solid waste incineration ash, silica fume, fly ash, bottom ash, ground pumice, biomass ash, halloysite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag phosphorous slag, bauxite slag/residue, zinc slag, lead slag, silicates, aluminosilicate, or their combinations. The lime and pozzolanic material are subjected to milling processes to achieve the desired properties of the cementitious material with a low CO₂ footprint.

### CROSS-REFERENCE TO RELATED APPLICATIONS

This application claims benefit of and priority to U.S. Provisional Patent Application No. 63/498,688 titled “Compositions and Methods of Making Cementitious Binders with Low CO₂ Footprint” filed Apr. 27, 2023, the disclosure of which is incorporated by reference herein in its entirety.

### BACKGROUND

Cementitious materials are crucial components in building materials and other industries. One of the most common cementitious material is ordinary Portland cement (OPC). Production of OPC accounts for 8% of total CO₂ emissions worldwide and it is estimated to increase each year because of the increasing demand for OPC. Another environmental concern is the significant energy use during the production of OPC. Accordingly, there is a desire to provide cementitious materials which have a smaller environmental footprint. The main CO₂ footprint of the production is chemical and thermal CO₂. The chemical CO₂ comes from the calcination of limestone and thermal CO₂ comes from fuel burning in the kiln for the calcination and clinkering processes. Accordingly, there is a desire to bypass these steps to produce CO₂ free cementitious materials.

### SUMMARY

In some aspects, the techniques described herein relate to a cementitious material with low CO₂ footprint compromising: a lime including CaO, Ca(OH)₂, or combinations thereof, and a pozzolanic material including metakaolin, calcined clay, volcanic tuffs, calcined shale, municipal solid waste incineration ash, silica fume, fly ash, bottom ash, ground pumice, biomass ash, halloysite, electric arc furnace slag (EAF), reducing steel slag, oxidizing steel slag, converter steel slag, basic oxygen furnace slag, ladle slag, slow or fast cooled steel slag, ground granulated blast furnace slag (GGBFS), air-cooled slag, copper slag, Solvay slag, phosphorous slag, bauxite slag/residue, zinc and lead slag, silicates, aluminosilicate, or combinations thereof; wherein the lime and the pozzolanic material are milled.

In some aspects, the techniques described herein relate to a cementitious material, wherein the ratio of the lime to the pozzolanic material is about 0.05 to about 9.

In some aspects, the techniques described herein relate to a cementitious material, wherein the cementitious material has a particle size is about 1 μm to about 1000 μm.

In some aspects, the techniques described herein relate to a cementitious material, wherein the cementitious material further includes a pH-regulating admixture, a curing enhancer, an agglomeration reducer, a water-reducing admixture, a retarder, a strength enhancer, a corrosion inhibitor, a shrinkage reducer, a crack reducer, an air entrainer, a viscosity modifier, or combinations thereof.

In some aspects, the techniques described herein relate to a cementitious material, further including one or more alkali activators.

In some aspects, the techniques described herein relate to a cementitious material, wherein the one or more alkali activators include potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium aluminates, calcium sulfate, calcium aluminum silicates, calcium silicate hydrates, calcium aluminum silicate hydrates,, ordinary Portland cement (OPC), recycled high alkalinity concrete, or combinations thereof.

In some aspects, the techniques described herein relate to a cementitious material, further including one or more aluminosilicates comprising zeolite, basalt, granite, pumice, mine tales, clay, halloysite, mining waste, or cement kiln dust.

In some aspects, the techniques described herein relate to a composite material including cementitious material, carbonatable material, carbonated materials and one or more fillers.

In some aspects, the techniques described herein relate to a cementitious material, wherein the cementitious material has 3, 7, and 28 day compressive strengths of at least 1890 psi, 2900 psi and 4060 psi respectively, when the cementitious material is formed into 2 inch mortar cubes.

In some aspects, the techniques described herein relate to a cementitious material, wherein the cementitious material does not contain ordinary Portland cement, or other types of cement, strength enhancers, alkali activators, or combinations thereof.

In some aspects, the techniques described herein relate to a cementitious material, wherein the cementitious material has a compressive strength comparable to the compressive strength of a cementitious material that contains ordinary Portland cement, different types of cement, strength enhancers, alkali activators, or combinations thereof.

In some aspects, the techniques described herein relate to a method of making a cementitious material, including: combining a lime, wherein the lime includes CaO, Ca(OH)₂, or combinations thereof, and a pozzolanic material, wherein the pozzolanic material includes metakaolin, calcined clay, volcanic tuffs, calcined shale, municipal solid waste incineration ash, silica fume, fly ash, bottom ash, ground pumice, biomass ash, halloysite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag, phosphorous slag, bauxite slag/residue, zinc slag, and lead slag, silicates, aluminosilicate, or combinations thereof, wherein combining the lime and the pozzolanic material includes milling.

In some aspects, the techniques described herein relate to a method, further including the grinding, sieving, or combinations thereof the lime, the pozzolanic material, or combinations thereof.

In some aspects, the techniques described herein relate to a method, further including milling the lime and the pozzolanic material, wherein the milling is performed with a ball mill, tower mill, pebble mill, high-pressure grinding rolls, autogenous mill, rod mill, or combinations thereof.

In some aspects, the techniques described herein relate to a method, wherein the lime, the pozzolanic material, or combinations thereof are milled for a period of about 1 minute to about 24 hours.

In some aspects, the techniques described herein relate to a method, wherein the lime and the pozzolanic material are ground, milled, sieved, or combinations thereof separately, thereof prior to combining.

In some aspects, the techniques described herein relate to a method, wherein the lime and the pozzolanic material are ground, milled, sieved, or combinations thereof together.

In some aspects, the techniques described herein relate to a method, further including adding a pH-regulating admixture, a curing enhancer, an agglomeration reducer, a water reducing admixture, a retarder, a strength enhancer, a corrosion inhibitor, a shrinkage reducer, a crack reducer, an air entrainer, a viscosity modifier, or combinations thereof.

In some aspects, the techniques described herein relate to a method, further including adding an alkali activator.

In some aspects, the techniques described herein relate to a method, wherein the lime is sized to about 1 μm to about 1000 μm.

In some aspects, the techniques described herein relate to a method, wherein the pozzolanic material is sized to about 1 μm to about 1000 μm.

In some aspects, the techniques described herein relate to a method, wherein the pozzolanic material comprises one or more aluminosilicates comprising zeolite, basalt, granite, pumice, mine tales, clay, halloysite, mining waste, or cement kiln dust.

In some embodiments, there is provided cementitious material with low CO₂ footprint including a lime including CaO, Ca(OH)₂, or combinations thereof, and a silicate material; wherein the lime and the silicate material are milled. In some embodiments, the silicate material includes aluminosilicates. In some embodiments, the silicate material includes one or more of zeolites, basalt, granite, pumice, mine tales, clay, halloysite, mining waste, cement kiln dust.

### DETAILED DESCRIPTION

Provided herein is a cementitious material with a low CO₂ footprint and methods of making the same. This disclosure includes processing methods of the lime and pozzolanic material that do not require adding extra components, though some embodiments include additional components as well. Cementitious materials which include lime and pozzolanic materials are known, but typically require the addition of other additives to achieve acceptable compressive strength and other performance properties. The present disclosure provides compositions and methods that can include only a lime and a pozzolanic material while achieving performance comparable to Portland cement composites.

There is provided a cementitious material that has a low CO₂ footprint, which includes lime comprising CaO, Ca(OH)₂, combinations thereof, and a pozzolanic material including metakaolin, calcined clay, volcanic tuffs, calcined shale, municipal solid waste incineration ash, silica fume, fly ash, bottom ash, ground pumice, biomass ash, halloysite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag, phosphorous slag, bauxite slag/residue, zinc slag, lead slag, silicates, aluminosilicate, or any combinations thereof, wherein the lime and the pozzolanic material are milled or mixed via other mechanical size reduction methods such as grinders. Granulators, impact mixers, or mechanochemical techniques are used to enhance the reactivity and/or the chemical bonds between the materials, without wishing to be bound by theory.

In some aspects, the lime includes CaO, Ca(OH)₂, or combinations thereof. In some aspects, the lime may include any amount or ratio of each of CaO and Ca(OH)₂. For example, the lime may include 100% CaO, 100% Ca(OH)₂, or a ratio of CaO and Ca(OH)₂. In such embodiments, the ratio is not particularly limited. In some aspects, Ca(OH)₂ is produced from Ca-bearing materials. In some aspects, Ca(OH)₂ can be synthesized in the laboratory. The source of Ca(OH)₂ is not particularly limited, and includes Ca(OH)₂ which is recovered or otherwise isolated from waste, industrial byproducts, and the like.

In some aspects, the pozzolanic material includes a silicate or aluminosilicate mineral which can be natural, synthetic, or any industrial material, including metakaolin, calcined clay, volcanic tuffs, calcined shale, municipal solid waste incineration ash, silica fume gaize, fly ash, bottom ash, ground pumice, biomass ash, halloysite, electric arc furnace slag (EAF), reducing steel slag, oxidizing steel slag, converter steel slag, basic oxygen furnace slag, ladle slag, slow or fast cooled steel slag, ground granulated blast furnace slag (GGBFS), air-cooled slag, copper slag, Solvay slag, phosphorous slag, bauxite slag/residue, zinc slag, copper slag, and lead slag, silicates, aluminosilicate, or combinations thereof. The pozzolanic material may be recovered from waste or industrial byproducts. Examples of suitable materials are described in U.S. Provisional Patent Application No. 63/453,437, filed on Mar. 20, 2023, which is incorporated by reference herein in its entirety.

In some embodiments, the majority of the pozzolanic material is not in an amorphous form.

In some aspects, the cementitious material includes lime and pozzolanic material and does not include other components. In some aspects, the cementitious material includes the lime and the pozzolanic material in a of about 0.05 to about 9. In some embodiments, the ratio is about 90% to 10%. In some embodiments, the ratio is about 80% to 20%. In some aspects, the lime to pozzolanic material ratio of the cementitious material is about 70% to 30%. In some aspects, the lime to pozzolanic material ratio of the cementitious material is about 60% to 40%. In some aspects, the lime to pozzolanic material ratio of the cementitious material is about 50% to 50%. In some aspects, the lime to pozzolanic material ratio of the cementitious material is about 40% to 60%. In some aspects, the lime to pozzolanic material ratio of the cementitious material is about 30% to 70%. In some aspects, the lime to pozzolan ratio of the cementitious material is about 20% to 80%. In some embodiments, the ratio is about 10% to 90%. In some embodiments, the ratio is about 5% to 95% Any value or range contained within the above ratios is within the scope of this disclosure. In some embodiments, the cementitious material includes lime, pozzolanic material, and other components familiar to those skilled in the art, such as activators or other additives.

In some embodiments, the cementitious material has a particle size of about 1 μm to about 1000 μm, such as about 1 μm, about 10 μm, about 100 μm, about 500 μm, about 1000 μm, or any range or value contained therein.

In some embodiments, the cementitious material includes a pH-regulating admixture, a curing enhancer, an agglomeration reducer, a water-reducing admixture, a retarder, a strength enhancer, a corrosion inhibitor, a shrinkage reducer, a crack reducer, an air entrainer, a viscosity modifier, or combinations thereof. In some embodiments, the cementitious material further includes one or more alkali activators.

In some aspects, the lime may have a mean particle size of about 1 μm to about 10 μm, about 1 μm to about 20 μm, about 1 μm to about 50 μm, about 1 μm to about 100 μm, about 1 μm to about 150 μm, about 1 μm to about 200 μm, about 1 μm to about 500 μm, about 1 μm to about 1000 μm, or any range or value contained therein.

In some aspects, the pozzolanic material may have a mean particle size of about 1 μm to about 10 μm, about 1 μm to about 20 μm, about 1 μm to about 50 μm, about 1 μm to about 100 μm, about 1 μm to about 150 μm, about 1 μm to about 200 μm, about 1 μm to about 500 μm, about 1 μm to about 1000 μm, or any range or value contained therein.

In some embodiments, there is provided a composite material which includes the cementitious material of any embodiment or combination of embodiments as described herein, carbonatable material, carbonated materials and one or more fillers. In some aspects, the cementitious material or the composite material may be combined with water to form cement. In some embodiments, the lime and the pozzolanic material are mixed together to form a cementitious material before being combined with water.

In some aspects, the water to cementitious material ratio is at least 0.20. In some aspects, the water to cementitious material ratio is at least 0.25. In some aspects, the water to cementitious material ratio is at least 0.30. In some aspects, the water to cementitious material ratio is at least 0.35. In some aspects, the water to binder ratio is at least 0.40. In some aspects, the water to binder ratio is at least 0.45.

In some aspects, the cementitious material may contain one or more admixtures such as pH regulating admixture, curing enhancer, agglomeration reducer, water reducing admixture, retarder, strength enhancer, corrosion inhibitor, shrinkage reducer, crack reducer, air entrainer, viscosity modifier, or combinations thereof.

In some aspects, the performance specifications of the cementitious material may be further increased by adding one or more alkali activators. In some embodiments, the alkali activator includes potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium aluminates, calcium sulfate, calcium aluminum silicates, calcium silicate hydrates, calcium aluminum silicate hydrates, ordinary Portland cement (OPC), recycled high alkalinity concrete, or combinations thereof. Without wishing to be bound by theory, the addition of the alkali activator may improve the performance of the cementitious material.

In some aspects, the cementitious material may further include other aluminosilicate sources such as zeolites, zeolite fines, basalt, granite, pumice, mine tales, clay, halloysite, mining waste, cement kiln dust, or combinations thereof. Without wishing to be bound by theory, these materials may be added to increase the aluminosilicate amount in the cementitious material.

In some aspects, the composite material made from lime, pozzolanic material, and/or zeolite may further include one or more fillers. In some aspects, the filler may include crushed stone, sand, recycled aggregate, granite, quartz, sand, limestone, construction sand, gravel, rocks, or combinations thereof.

In some aspects, the cementitious material has 3, 7, and 28 day compressive strengths of at least 1890 psi, 2900 psi, and 4060 psi, respectively, when the cementitious material is formed into 2-inch mortar cubes. The formation of 2-inch mortar cubes would be familiar to one skilled in the art and may include the combination of the cementitious material of the present disclosure with water. Any method of measuring compressive strength familiar to those skilled in the art may be utilized.

In some embodiments, the cementitious material does not include ordinary Portland cement or other types of cement, strength enhancers, alkali activators, or combinations thereof. Without wishing to be bound by theory, the cementitious material of the present disclosure has a compressive strength that may be comparable to the compressive strength of a cementitious material which includes ordinary Portland cement, or other types of cements, strength enhancers, alkali activators, or combinations thereof.

There is also provided a method of making a cementitious material as described herein. The method includes, in some embodiments, combining a lime, wherein the lime includes CaO, Ca(OH)₂, or combinations thereof, and a pozzolanic material, wherein the pozzolanic material includes metakaolin, calcined clay, volcanic tuffs, calcined shale, municipal solid waste ash, silica fume, fly ash, bottom ash, ground pumice, biomass ash, halloysite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag phosphorous slag, bauxite slag/residue, zinc slag, and lead slag, silicates, aluminosilicate, or combinations thereof, wherein combining the lime and the pozzolanic material includes milling. In some embodiments, the lime and the pozzolanic material are mixed via other mechanical size reduction methods such as grinders. Granulators, impact mixers, or mechanochemical techniques may be used to enhance the reactivity and/or the chemical bonds between the materials, without wishing to be bound by theory.

In some aspects, the lime and/or the pozzolanic material are processed to obtain a particular size range. In some aspects, the processing includes grinding, milling, sieving, or combinations thereof. Milling may be performed with ball mill, tower mill, pebble mill, high pressure grinding rolls, autogenous mill, rod mill, and the like, or combinations thereof. In some embodiments, the lime, the pozzolanic material, or combinations thereof are ground, milled, sieved, or combinations thereof.

In some aspects, the lime is ground, milled, sieved, or combinations thereof. In some aspects, the pozzolanic material is ground, milled, sieved, or combinations thereof. In some embodiments, the lime and the pozzolanic material are ground, milled, sieved, or combinations thereof separately, prior to combining. In some aspects, the lime and pozzolanic material are ground, milled, sieved, or combinations thereof together.

In some aspects, the milling time is between 1 to 30 minutes. In some aspects, the milling time is 1 hour. In some aspects, the milling time is 2 hours. In some aspects, the milling time is 3 hours. In some aspects, the milling time is 6 hours. In some aspects, the milling time is 8 hours. In some aspects, the milling time is 16 hours. In some aspects, the milling time is 24 hours. In some embodiments, the lime, the pozzolanic material, or combinations thereof are milled for a period of about 1 minute to about 24 hours, or any range or value contained therein.

In some embodiments, the method further includes adding a pH-regulating admixture, a curing enhancer, an agglomeration reducer, a water-reducing admixture, a retarder, a strength enhancer, a corrosion inhibitor, a shrinkage reducer, a crack reducer, an air entrainer, a viscosity modifier, or combinations thereof. In some embodiments, the method further includes adding an alkali activator.

In some embodiments, the method includes sizing the lime to about 1 μm to about 1000 μm. In some embodiments, the method includes sizing the pozzolanic material to about 1 μm to about 1000 μm. In some embodiments, the method includes sizing the lime and the pozzolanic material to about 1 μm to about 1000 μm.

Prophetic examples of cementitious materials having a low CO₂ footprint are also disclosed and contemplated. In some embodiments, there is provided cementitious material with a low CO₂ footprint including a lime including CaO, Ca(OH)₂, or combinations thereof, and a silicate material; wherein the lime and the silicate material are milled. In some embodiments, the silicate material is an aluminosilicate. In some embodiments, the silicate material is a zeolite, basalt, granite, or pumice. In some embodiments, the cementitious material including a lime and a silicate material does not include ordinary Portland cement and exhibits comparable properties such as compressive strength to cementitious materials which do include ordinary Portland cement.

This disclosure is not limited to the particular systems, devices, and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

As used herein, the term “about” means plus or minus 10% of the numerical value of the number with which it is being used. For example, “about 50%” means in the range of 45-55%.

The numerical values used in this disclosure are to be construed as being characterized by the above described “about”, and are also intended to include the exact numerical values disclosed herein. The ranges disclosed here include the upper and lower limits.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general, such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third, and upper third, et cetera. As will also be understood by one skilled in the art all languages such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A cementitious material with a low CO₂ footprint comprising:
a lime comprising CaO, Ca(OH)₂, or combinations thereof, and
a pozzolanic material comprising metakaolin, calcined clay, volcanic tuffs, calcined shale, municipal solid waste incineration ash, silica fume, fly ash, bottom ash, ground pumice, biomass ash, halloysite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag phosphorous slag, bauxite slag/residue, zinc slag, lead slag, silicates, aluminosilicate, or combinations thereof;
wherein the lime and the pozzolanic material are milled.

2. The cementitious material of claim 1, wherein the ratio of the lime to the pozzolanic material is about 0.05 to about 9.

3. The cementitious material of any one of claims 1-2, wherein the cementitious material has a particle size is about 1 μm to about 1000 μm.

4. The cementitious material of any one of claims 1-3, wherein the cementitious material further comprises a pH regulating admixture, a curing enhancer, an agglomeration reducer, a water reducing admixture, a retarder, a strength enhancer, a corrosion inhibitor, a shrinkage reducer, a crack reducer, an air entrainer, a viscosity modifier, or combinations thereof.

5. The cementitious material of any one of claims 1-4, further comprising one or more alkali activators.

6. The cementitious material of any one of claims 1-5, wherein the one or more alkali activators comprise potassium silicates, potassium carbonate, potassium phosphate, potassium bicarbonate, potassium nitrate, potassium hydroxide, potassium oxide, potassium sulfate, sodium silicates, sodium carbonate, sodium phosphate, sodium bicarbonate, sodium nitrate, sodium hydroxide, sodium oxide, sodium sulfate, calcium nitrate, calcium silicates, calcium aluminates, calcium sulfate, calcium aluminum silicates, calcium silicate hydrates, calcium aluminum silicate hydrates, ordinary Portland cement (OPC), recycled high alkalinity concrete, or combinations thereof.

7. The cementitious material of any one of claims 1-6, further comprising one or more aluminosilicate sources comprising zeolites, zeolite fines, basalt, granite, pumice, mine tales, clay, halloysite, mining waste, or cement kiln dust.

8. A composite material comprising the cementitious material of any one of claims 1-7, carbonatable material, carbonated materials, and one or more fillers.

9. The cementitious material of claim 1 or the composite material of claim 8, wherein the cementitious material has 3, 7, and 28 day compressive strengths of at least 1890 psi, 2900 psi, and 4060 psi respectively, when the cementitious material of claim 1 and claim 8 is formed into 2-inch mortar cubes.

10. The cementitious material of claim 1 or the composite material of claim 8, wherein the cementitious material does not contain ordinary Portland cement, other types of cement, strength enhancers, alkali activators, or combinations thereof.

11. The cementitious material of claim 1 or the composite material of 8, wherein the cementitious material has a compressive strength that is comparable to the compressive strength of a cementitious material that contains ordinary Portland cement, other types of cement, strength enhancers, alkali activators, or combinations thereof.

12. A method of making a cementitious material, comprising:
combining a lime, wherein the lime comprises CaO, Ca(OH)₂, or combinations thereof, and
a pozzolanic material, wherein the pozzolanic material comprises metakaolin, calcined clay, volcanic tuffs, calcined shale, municipal solid waste ash, silica fume, fly ash, bottom ash, ground pumice, biomass ash, halloysite, electric arc furnace slag (EAF), reducing steel slag, oxidizing steel slag, converter steel slag, basic oxygen furnace slag, ladle slag, slow or fast cooled steel slag, GGBFS, air-cooled slag, copper slag, Solvay slag, phosphorous slag, bauxite slag/residue, zinc slag, lead slag, silicates, aluminosilicate, or combinations thereof,
wherein combining the lime and the pozzolanic material comprises milling.

13. The method of claim 12, further comprising grinding, sieving, or combinations thereof the lime, the pozzolanic material, or combinations thereof.

14. The method of any one of claims 12-13, further comprising milling the lime and the pozzolanic material, wherein the milling is performed with a ball mill, tower mill, pebble mill, high-pressure grinding rolls, autogenous mill, rod mill, or combinations thereof.

15. The method of any one of claims 12-14, wherein the lime, the pozzolanic material, or combinations thereof are milled for a period of about 1 minute to about 24 hours.

16. The method of any one of claims 12-15, wherein the lime and the pozzolanic material are ground, milled, sieved, or combinations thereof separately, before combining.

17. The method of any one of claims 12-16, wherein the lime and the pozzolanic material are ground, milled, sieved, or combinations thereof together.

18. The method of any one of claims 12-17, further comprising adding a pH regulating admixture, a curing enhancer, an agglomeration reducer, a water reducing admixture, a retarder, a strength enhancer, a corrosion inhibitor, a shrinkage reducer, a crack reducer, an air entrainer, a viscosity modifier, or combinations thereof.

19. The method of any one of claims 12-18, further comprising adding an alkali activator.

20. The method of any one of claims 12-19, wherein the lime is sized to about 1 μm to about 1000 μm.

21. The method of any one of claims 12-20, wherein the pozzolanic material is sized to about 1 μm to about 1000 μm.

22. The method of claim 12, wherein the pozzolanic material comprises one or more aluminosilicates comprising zeolite, basalt, granite, pumice, mine tales, clay, halloysite, mining waste, or cement kiln dust.
